(19) United States
(12) Patent Application Publication
(10) Pub. No.: US 2019/0358733 A1
(43) Pub. Date: Nov. 28, 2019

(54) OVERLAPPING SPOT WELDS FOR IMPROVED MECHANICAL PERFORMANCE AND WELD REPAIR

(71) Applicant: GM GLOBAL TECHNOLOGY OPERATIONS LLC, DETROIT, MI (US)

(72) Inventors: David R. Sigler, Shelby Townhip, MI (US); Amberlee S. Haselhuhn, Shelby Township, MI (US)

(21) Appl. No.: 15/986,165

(22) Filed: May 22, 2018

(51) Int. Cl. B23K 11/11; B23K 11/20; B32B 15/01

(52) U.S. Cl. CPC B23K 11/115; B32B 15/012; B23K 11/20

(57) ABSTRACT

A method of resistance spot welding is provided that includes overlapping weld joints. The method may be used to repair a discrepant weld joint or to strengthen a weld joint. Pressure and electrical current is initially applied to workpieces via weld faces of electrodes to form an initial spot weld joint attempt between the first and second workpieces, and then the initial application of pressure is removed. A subsequent application of pressure and electrical current is then applied to the workpieces via the weld faces to form an overlapping spot weld joint between the first and second workpieces. The overlapping spot weld joint overlaps with the initial spot weld joint attempt. The initial spot weld joint attempt may be successful or not, such that the overlapping weld joint either repairs or strengthens the initial weld joint attempt. Overlap of the welds may be 10-100%.

### TECHNICAL FIELD

The technical field of this disclosure relates generally to resistance spot welding and, more particularly, to a methodology of resistance spot welding workpiece stack-ups that involves a technique of overlapping.

### INTRODUCTION

Resistance spot welding is a well-known joining technique that relies on resistance to the flow of an electrical current through overlapping metal workpieces and across their faying interface(s) to generate the heat needed for welding. To carry out such a welding process, a set of opposed spot welding electrodes is clamped at aligned spots on opposite sides of the workpiece stack-up, which typically includes two or three metal workpieces arranged in a lapped configuration. Electrical current is then passed through the metal workpieces from one welding electrode to the other. Resistance to the flow of this electrical current generates heat within the metal workpieces and at their faying interface(s). When the workpiece stack-up includes similar metal workpieces, such as two or more overlapping steel workpieces or two or more overlapping aluminum workpieces, the generated heat creates a molten weld pool that grows to consume the faying interface(s) and thus extends through all or part of each of stacked metal workpieces. In that regard, each of the similarly-composed metal workpieces contributes material to the comingled molten weld pool. Upon termination of the passage of electrical current through the workpiece stack-up, the molten weld pool solidifies into a weld nugget that fusion welds the adjacent metal workpieces together.

The resistance spot welding process proceeds somewhat differently when the workpiece stack-up includes dissimilar metal workpieces. Most notably, when the workpiece stack-up includes an aluminum workpiece and a steel workpiece that overlap and confront to establish a faying interface, as well as possibly one or more flanking aluminum and/or one or more flanking steel workpieces (e.g., aluminum-aluminum-steel, aluminum-steel-steel, aluminum-aluminum-aluminum-steel, aluminum-steel-steel-steel), the heat generated within the bulk workpiece material and at the faying interface of the aluminum and steel workpiece creates a molten weld pool within the aluminum workpiece. The faying surface of the steel workpiece remains solid and intact and, consequently, the steel workpiece does not melt and comingle with the molten weld pool because of its much higher melting point, although elements from the steel workpiece, such as iron, may diffuse into the molten weld pool. This molten weld pool wets the confronting faying surface of the steel workpiece and, upon cessation of the current flow, solidifies into a weld joint that weld bonds or brazes the two dissimilar workpieces together.

Resistance spot welding is one of a handful of joining processes that can be used during the manufacture of multi-component assemblies. The automotive industry, for example, currently secures various vehicle body members (e.g., body sides, cross-members, pillars, floor panels, roof panels, engine compartment members, trunk compartment members, etc.) into an integrated multi-component body structure, often referred to as a body-in-white, that supports the subsequent installation of various vehicle closure members (e.g., doors, hoods, trunk lids, lift gates, etc.). Recently, in an effort to assimilate lighter weight materials into a vehicle body structure which, in turn, can boost the fuel economy of the vehicle, there has been interest in strategically incorporating both aluminum workpieces and steel workpieces into the body-in-white. A typical process for structurally securing the body-in-white involves, first, positioning and supporting the vehicle body members relative to one another precisely as intended in the final body-in-white structure. The vehicle body members in need of joining are laid up or fitted together such that flanges or other bonding regions of the body members overlap to provide a workpiece stack-up of two or more overlapping workpieces. When the fixture of vehicle body members includes workpiece stack-ups with different combinations of metal workpieces, the workpiece stack-ups are also joined with self-piercing rivets, although recent technological advances have made resistance spot welding a viable and dependable option. The formation of spot welds and the installation of self-piercing rivets are carried out by weld and rivet guns according to a programmed and coordinated sequence until all of the vehicle body members are secured in place. The overall assembly process is repeated over and over on a production line with the goal of steadily producing body-in-white structures at an acceptable output rate with minimum unnecessary downtime.

The initiative to develop a resistance spot welding approach that can successfully spot weld the diverse combinations of metal workpieces that may be found in a body-in-white has recently gained traction, as such an approach could significantly reduce or altogether eliminate the need to use costly, weight-adding, and laborious-to-install rivets (and their associated rivet guns) during the construction of the body-in-white. But spot welding the various combinations of metal workpieces that may be presented in a workpiece stack-up poses certain challenges. First, the melting ranges for aluminum alloys and steel materials are vastly different, i.e., approximately 900° C. apart, which results in aluminum melting while the steel remains solid and can create solidification porosity along the faying interface that weakens the joint. Second, aluminum and steel form a series of brittle intermetallic compounds at the faying interface that, if excessively thick, can weaken the joint. Third, the oxide coating on aluminum interferes with current flow and can become incorporated within the growing aluminum weld nugget creating a series of microcracks along the faying interface that weakens the joint. These challenges make producing strong joints difficult such that even sound Al-steel welds can be weaker than Al—Al counterparts. In some cases, Al-steel welds even break apart and become discrepant, and the workpieces are scrapped.

### SUMMARY

A method of resistance spot welding is provided that includes performing overlapping spot welds to strengthen the weld joints and/or to repair discrepant weld joints. Thus, a workpiece stack-up assembly may be weld bonded together that includes a plurality of overlapping weld joints. Previously, it was believed that due to the challenges described above, creating overlapping weld joints would cause the joints to become discrepant and not to hold, and therefore, any such overlapping of weld joints was directed against.

In one form, which may be combined with or separate from the other forms disclosed herein, a method of resistance spot welding workpiece stack-ups is provided that includes providing a metallic first workpiece and providing a metallic second workpiece adjacent to the first workpiece. The method further comprises providing a set of opposed welding electrodes including a first electrode and a second electrode. The first and second electrodes each have weld faces. The first electrode is first disposed on a side of the first workpiece in a first relative position between the set of electrodes and the workpieces, and the second electrode is first disposed on a side of the second workpiece in the first relative position between the set of electrodes and the workpieces. The method includes applying an initial application of pressure to the workpieces via the weld faces of the set of electrodes in the first relative position between the set of electrodes and the workpieces and passing current between the electrodes to heat the workpieces and form an initial spot weld joint attempt between the first and second workpieces. After applying the initial application of pressure to the workpieces via the weld, the method includes removing the initial application of pressure. The method then includes applying a subsequent application of pressure to the workpieces via the weld faces of the set of electrodes and passing current between the electrodes to heat the workpieces to form an overlapping spot weld joint between the first and second workpieces. The overlapping spot weld joint overlaps with the initial spot weld joint attempt.

In another form, which may be combined with or separate from the other forms disclosed herein, a spot-welded workpiece assembly is provided that includes a metallic first workpiece and a metallic second workpiece spot welded to the first workpiece by a plurality of overlapping spot weld joints. Each overlapping spot weld joint overlaps with another overlapping spot weld joint by 10-100%.

In yet another form, which may be combined with or separate from the other forms disclosed herein, a method of repairing a discrepant weld joint or weld joint known or suspected of being weak is provided. The method includes providing a metallic first workpiece and providing a metallic second workpiece adjacent to the first workpiece. The first workpiece has an initial weld impression formed therein from a previous spot weld attempt between the first and second workpieces. The method includes providing a first electrode adjacent to the initial weld impression formed in the first workpiece. Each of the first and second electrodes have a weld face. The method includes applying pressure to the workpieces via the weld faces of the set of electrodes, pressing the first electrode into a contact point on the first workpiece that overlaps with the initial weld impression, and passing current through the workpieces via the electrodes to form a repaired spot weld joint between the first and second workpieces.

Additional features may be provided, including but not limited to the following: the second workpiece being formed of a steel alloy; the first workpiece being formed of aluminum or an aluminum alloy; wherein the initial spot weld joint attempt results in a discrepant weld; performing the step of applying the subsequent application of pressure in the first relative position; performing the step of applying the subsequent application of pressure in a second relative position between the set of electrodes and the workpiece, the second relative position being different than the first relative position; and waiting a period of time, such as at least three seconds, after the step of applying the initial application of pressure to the workpieces and prior to performing the step of applying subsequent application of pressure to the workpieces.

Further additional features may be provided, including but not limited to the following: contacting the first workpiece with the first weld face during the initial application of pressure; removing contact between the first weld face and the first workpiece during the step of removing the initial application of pressure; contacting the first workpiece with the first weld face during the subsequent application of pressure; wherein the steps of heating the workpieces are accomplished by passing current through the workpieces via the electrodes; the overlapping spot weld joint overlapping with the initial spot weld joint attempt by 95-100%; the weld nugget formed by the overlapping spot weld joint overlapping with the nugget formed by the initial spot weld joint attempt by 10-75%, for example, at the faying surface; the weld nugget formed by the overlapping spot weld joint overlapping with the nugget formed by the initial spot weld joint attempt by 25-50%; the initial spot weld joint attempt resulting in an initial spot weld joint that bonds the first workpiece to the second workpiece; the overlapping spot weld joint further bonding the first workpiece to the second workpiece; the overlapping spot weld joint being a second spot weld joint; after passing current through the workpieces via the first and second electrodes in the second relative position between the set of electrodes and the workpieces, passing current through the workpieces via the first and second electrodes and applying pressure to the workpieces via the weld faces of the set of electrodes in a third relative position between the set of electrodes and the workpieces to form a third spot weld joint between the first and second workpieces; the third relative position between the set of electrodes and the workpieces being different than each of the first and second relative positions between the set of electrodes and the workpieces; the third overlapping spot weld joint overlapping with the second spot weld joint so that the initial spot weld joint, the second spot weld joint, and the third spot weld joint form a continuous weld joint between the first and second workpieces; each of the weld faces comprising oxide-disrupting structural features, the oxide-disrupting structural features being in the form of one of or a combination of a series of upstanding circular ridges, a series of recessed circular grooves, and a microtexture; disposing a metallic third workpiece between the first and second workpieces; the third workpiece being spot welded to the first and second workpieces by the overlapping spot weld joint; the third workpiece between formed of a steel alloy, aluminum, or an aluminum alloy; providing at least three overlapping spot weld joints that form a continuous weld joint between the first and second workpieces; forming a repaired weld on the first workpiece; and wherein the repaired weld overlaps with an initial weld by 95-100%.

The above and other advantages and features will become apparent to those skilled in the art from the following detailed description and accompanying drawings.

### BRIEF DESCRIPTION OF THE DRAWINGS

The drawings described herein are for illustration purposes only and are not intended to limit the scope of the present disclosure in any way.

FIG. 1 is a perspective view illustrating a multi-component integrated assembly in the form of an automobile body-in-white that may be secured together from a fixture of individual vehicle body members by a plurality spot welds, including one or more overlapping spot welds, in accordance with the principles of the present disclosure;

FIG. 2 is an end view of a workpiece stack-up that includes at least a first metal workpiece and a second metal workpiece for spot welding as part of the overall construction of the multi-component integrated assembly depicted in FIG. 1, which is also applicable to a variety of other assemblies, according to the principles of the present disclosure;

FIG. 2A is an end view of another variation of a workpiece stack-up that includes three metal workpieces for spot welding as part of the overall construction of the multi-component integrated assembly depicted in FIG. 1, which is also applicable to a variety of other assemblies, according to the principles of the present disclosure;

FIG. 2B is an end view of yet another variation of a workpiece stack-up that includes four metal workpieces for spot welding as part of the overall construction of the multi-component integrated assembly depicted in FIG. 1, which is also applicable to a variety of other assemblies, according to the principles of the present disclosure;

FIG. 3 is a schematic side view illustrating a partial schematic view of a weld gun that carries a set of opposed welding electrodes and is configured to spot welding to spot weld workpiece stack-ups together, such as the workpiece stack-ups illustrated in FIGS. 2-2B, in accordance with the principles of the present disclosure;

FIG. 4 is a perspective view of a welding electrode that embodies a multiple ring domed (MRD) welding electrode design and that represents one possibility for the structure of each of the opposed welding electrodes carried by the weld gun shown in FIG. 3, according to the principles of the present disclosure;

FIG. 5 is a progression of cross-sectional views of a workpiece stack-up showing the formation of an initial aluminum-to-steel spot weld using welding electrodes, for example, as illustrated in FIGS. 3-4, and the method of the present disclosure, according to the principles of the present disclosure;

FIG. 6 is a progression of cross-sectional views of a workpiece stack-up showing the formation of an overlapping aluminum-to-steel spot weld after the formation of the initial spot weld of FIG. 5, using welding electrodes, for example, as illustrated in FIGS. 3-4, and the method of the present disclosure, according to the principles of the present disclosure;

FIG. 7 is a plan view illustrating a plurality of overlapping weld impressions of overlapping spot weld joints, such as the overlapping spot weld joints of FIG. 6, in accordance with the principles of the present disclosure;

FIG. 8 is a plan view illustrating a plurality of overlapping weld impressions of overlapping spot weld joints that form a continuous weld joint, in accordance with the principles of the present disclosure; and

FIG. 9 is a pulled-away progression of plan views of a workpiece showing the workpiece when an initial discrepant weld joint attempt is formed and when a good weld joint is formed, where the formation of the good weld was performed substantially 100% overlapping with the initial discrepant weld joint attempt, using welding electrodes, for example, as illustrated in FIGS. 3-4, and the method of the present disclosure, where an aluminum layer has been pulled away to illustrate weld marks at the faying surface of an underlying steel layer, according to the principles of the present disclosure.

### DETAILED DESCRIPTION

A method is disclosed that includes resistance spot welding by overlapping a number of weld joints to strengthen and/or repair spot weld joints. A resulting workpiece assembly is also disclosed that includes overlapping weld joints.

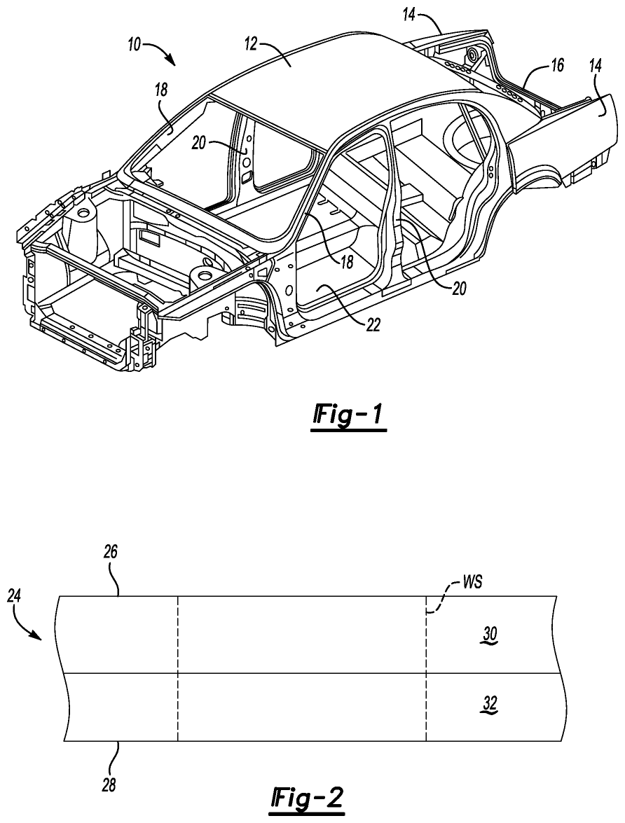

Referring now to FIG. 1, a multi-component integrated assembly 10 is illustrated in the form of a body-in-white during the manufacture of an automobile. The multi-component body-in-white assembly 10 includes a roof panel 12, rear quarter panels 14, a rear trunk wall 16, A pillars 18, B pillars 20, and floor members 22 and related underbody structure, among other vehicle body members. Certain of these vehicle body members may be formed of an aluminum workpiece, such as the roof and quarter panels 12, 14 and the trunk wall 16, and certain of the other vehicle body members may be formed of a steel workpiece, such as the A and B pillars 18, 20 and the floor members 22.

Prior to being secured together into the unitary, integrated body-in-white assembly 10, the various vehicle body members 12, 14, 16, 18, 20, 22 are positioned and supported relative to one another by a fixturing device or devices. In doing so, flanges or other bonding regions of the body members 12, 14, 16, 18, 20, 22 are arranged in lapped configurations with corresponding flanges or bonding regions of other body members to provide a multitude of workpiece stack-ups with two-side access where one or more resistance spot welds can be formed to secure the vehicle body members together that contribute to each particular stack-up. Some of the established workpieces stack-ups may include similar metal workpieces, i.e., all aluminum workpieces or all steel workpieces, while some of the stack-ups may include a combination of aluminum and steel workpieces. An intermediate organic material such as a weld-through adhesive or a sealer may optionally be included between the lapped workpieces in each stack-up if desired.

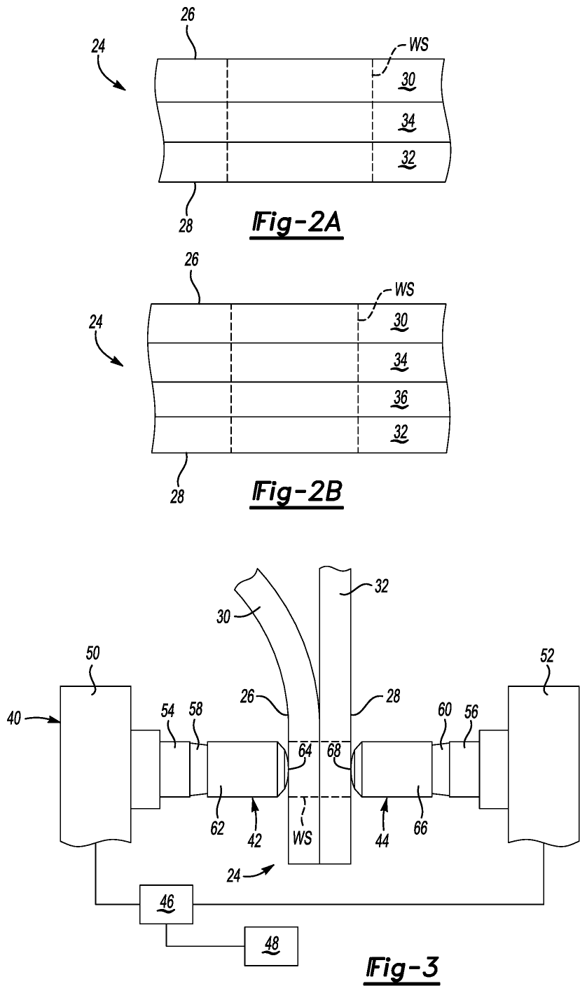

A workpiece stack-up 24 is shown in FIG. 2 that represents the various categories of workpiece stack-ups that are established for spot welding as part of the overall construction of multi-component body-in-white assembly 10. The workpiece stack-up 24 has a first side 26 and a second side 28 and includes at least a first metal workpiece 30 and an adjacent overlapping second metal workpiece 32. The first metal workpiece 30 provides the first side 26 of the stack-up 24 and the second metal workpiece 32 provides the second side 28. Each of the first and second sides 26, 28 is accessible to a spot welding electrode such that the workpiece stack-up 24 can be clamped between a pair of opposed spot welding electrodes at a weld site WS. In some implementations, the workpiece stack-up 24 includes only the first and second metal workpieces 30, 32 (a “2T” stack-up). In other implementations, a third metal workpiece 34 may be positioned between the first and second metal workpieces 30, 32 and extend through the weld site WS (a “3T” stack-up), as shown in FIG. 2A. Still further, in other implementations, a fourth metal workpiece 36 may be positioned between the first and second metal workpieces 30, 32 and extend through the weld site WS along with the third metal workpiece 34 (a “4T” stack-up), as shown in FIG. 2B. Further additional workpieces may be added in the stack-up, if desired, where aluminum sheets are stacked adjacent to each other and steel sheets are stacked adjacent to each other.

Referring back to FIG. 2, the second workpiece 32 may be formed of steel and the first workpiece 30 may be formed of unalloyed aluminum or an aluminum alloy, by way of example. For example, if alloyed, the aluminum alloy may include at least 85 wt % aluminum. The unalloyed aluminum or aluminum alloy workpiece 30 may be either coated or uncoated. Some notable aluminum alloys that may constitute the coated or uncoated aluminum substrate are an aluminum-magnesium alloy, an aluminum-silicon alloy, an aluminum-magnesium-silicon alloy, and an aluminum-zinc alloy. If coated, the aluminum substrate may include a surface layer of a refractory oxide material (native and/or produced during manufacture when exposed to high-temperatures, e.g., mill scale) comprised of aluminum oxide compounds and possibly other oxide compounds such as, for example, those of magnesium oxide if the aluminum substrate contains magnesium. The aluminum substrate may also be coated with a layer of zinc, tin, or a metal oxide conversion coating comprised of oxides of titanium, zirconium, chromium, or silicon, such as described in US Pat. Pub. No. 2014/0360986. The surface layer may have a thickness ranging from 1 nm to 10 μm and may be present on each side of the aluminum substrate. The aluminum workpiece 30 may have a thickness that ranges from 0.3 mm to 6.0 mm, or more narrowly from 0.5 mm to 3.0 mm, at least at the weld site WS.

The aluminum workpiece 30 may be provided in wrought or cast form. For example, the workpiece 30 may be composed of a 3XXX, 4xxx, 5xxx, 6xxx, or 7xxx series wrought aluminum alloy sheet layer, extrusion, forging, or other worked article. Alternatively, the workpiece 30 may be composed of a 4xx.x, 5xx.x, 6xx.x, or 7xx.x series aluminum alloy casting. Some more specific kinds of aluminum alloys that may be used include, but are not limited to, AA5754 and AA5182 aluminum-magnesium alloy, AA6111 and AA6022 aluminum-magnesium-silicon alloy, AA7003 and AA7055 aluminum-zinc alloy, and Al-10Si-Mg aluminum die casting alloy. The aluminum workpiece 30 may further be employed in a variety of tempers including annealed (O), strain hardened (H), and solution heat treated (T), if desired. When more than one aluminum or aluminum alloy workpiece 30 is present in the workpiece stack-up 24, the workpieces may be the same or different in terms of their compositions, thicknesses, and/or form (e.g., wrought or cast).

The steel workpiece 32 that may be included in the workpiece stack-up 24 contains a steel substrate of any of a wide variety of strengths and grades that is either coated or uncoated. The steel substrate may be hot-rolled or cold-rolled and may be composed of steel such as mild steel, interstitial-free steel, bake-hardenable steel, high-strength low-alloy (HSLA) steel, dual-phase (DP) steel, complex-phase (CP) steel, martensitic (MART) steel, transformation induced plasticity (TRIP) steel, twining induced plasticity (TWIP) steel, and boron steel such as when the steel workpiece includes press-hardened steel (PHS). If coated, the steel substrate preferably includes a surface layer of zinc (e.g., hot-dip galvanized or electrogalvanized), a zinc-iron alloy (e.g., galvannealed or electrodeposited), a zinc-nickel alloy, nickel, aluminum, an aluminum-magnesium alloy, an aluminum-zinc alloy, or an aluminum-silicon alloy, any of which may have a thickness of up to 50 μm and may be present on each side of the steel substrate. The steel workpiece 34 may have a thickness that ranges from 0.3 mm to 6.0 mm, or more narrowly from 0.6 mm to 2.5 mm, at least at the weld site WS.

When the workpiece stack-up 24 includes the first, second, and third metal workpieces 30, 34, 32, as shown in FIG. 2A, two of the adjacent metal workpieces 30, 34, 32, may be aluminum workpieces and the other metal workpiece may be a steel workpiece, or two of the adjacent metal workpieces 30, 34, 32 may be steel workpieces and the other metal workpiece may be an aluminum workpiece.

Finally, when the workpiece stack-up 24 includes the first, second, third, and fourth metal workpieces 30, 34, 36, 32, as shown in FIG. 2B, two of the adjacent metal workpieces 30, 34, 36, 32 may be aluminum workpieces and the other two adjacent metal workpieces may be steel workpieces, three of the adjacent metal workpieces 30, 34, 36, 32 may be aluminum workpieces and the other metal workpiece may be a steel workpiece, or three of the adjacent metal workpieces 30, 34, 36, 32 may be steel workpieces and the other metal workpiece may be an aluminum workpiece.

Referring now to FIG. 3, a weld gun 40 may form spot welds in the various assembled workpiece stack-ups 24 of the body-in-white assembly 10 to secure their constituent metal workpieces together. The weld gun 40 carries a first welding electrode 42 and an opposed second welding electrode 44. As used herein, a “weld,” “welded,” or “welding” is used to refer to a resistance spot welding process of joining that involves heating adjacent workpieces by passing an electrical current to resistively heat adjacent workpieces until at least one of the workpieces melts at a faying interface to join the adjacent workpieces together. Similarly, the phrase “spot weld” is also used here as a generic term that encompasses the weld nugget structure that fusion welds together overlapping aluminum workpieces or overlapping steel workpieces as well as a weld joint structure that weld bonds or brazes together an aluminum workpiece and an adjacent overlapping steel workpiece at each weld site WS where spot welding is performed.

The first and second welding electrodes 42, 44 are mechanically and electrically coupled to the weld gun 40, which can support forming a rapid succession of spot welds. The weld gun 40, for example, may be a C-type gun or an X-type gun, or some other type. A floor mounted, pedestal weld gun may be used when parts are sufficiently small to be manipulated by a robot, otherwise the weld gun 40 may be mounted on a robot capable of moving it in and around the fixture of vehicle body members to gain access to the workpiece stack-ups 24. Additionally, as illustrated schematically here, the weld gun 40 may be associated with a power supply 46 that delivers electrical current between the welding electrodes 42, 44 according to one or more programmed weld schedules administered by a weld controller 48. The weld gun 40 may also be fitted with coolant lines and associated control equipment in order to deliver a cooling fluid, such as water, to each of the welding electrodes 42, 44 during spot welding operations to help manage the temperature of the electrodes 42, 44.

The weld gun 40 includes a first gun arm 50 and a second gun arm 52. The first gun arm 50 is fitted with a shank 54 that secures and retains the first welding electrode 42 and the second gun arm 52 is fitted with a shank 56 that secures and retains the second welding electrode 44. The secured retention of the welding electrodes 42, 44 on their respective shanks 54, 56 can be accomplished by way of shank adapters 58, 60 that are located at axial free ends of the shanks 54, 56. In terms of their positioning relative to the workpiece stack-up 24, the first welding electrode 42 is positioned for contact with the first side 26 of the stack-up 24, and the second welding electrode 44 is positioned for contact with the second side 28 of the stack-up 24. The first and second weld gun arms 50, 52 are operable to converge or pinch the welding electrodes 42, 44 towards each other and to impose a clamping force on the workpiece stack-up 24 at the weld site WS once the electrodes 42, 44 are brought into contact with their respective workpiece stack-up sides 26, 28.

Each of the first and second welding electrodes 42, 44 may be constructed as a multi-ringed domed (“MRD”) welding electrode and is formed of an electrically conductive material such as, for example, a copper alloy. One specific example of a suitable copper alloy is a C15000 copper-zirconium alloy (CuZr) that contains 0.10 wt % to 0.20 wt % zirconium and the balance copper. Other copper materials may be employed including, for example, a C18200 copper-chromium alloy (CuCr) that includes 0.6 wt % to 1.2 wt % chromium and the balance copper; a C18150 copper-chromium-zirconium alloy (CuCrZr) that includes 0.5 wt % to 1.5 wt % chromium, 0.02 wt % to 0.20 wt % zirconium, and the balance copper; or a dispersion strengthened copper material such as copper with an aluminum oxide dispersion. Still further, other compositions that possess suitable mechanical and electrical/thermal conductivity properties may also be used including more resistive electrodes that are composed of a refractory metal (e.g., molybdenum or tungsten) or a refractory metal composite (e.g. tungsten-copper).

The first welding electrode 42 includes an electrode body 62 and a first weld face 64 and, likewise, the second welding electrode 44 includes an electrode body 66 and a second weld face 68. The weld faces 64, 68 of the first and second welding electrodes 42, 44 are the portions of the electrodes 42, 44 that are pressed against, and impressed into, the opposite sides 26, 28 of the workpiece stack-up 24 to communicate electrical current during each instance the weld gun 40 is operated to conduct spot welding.

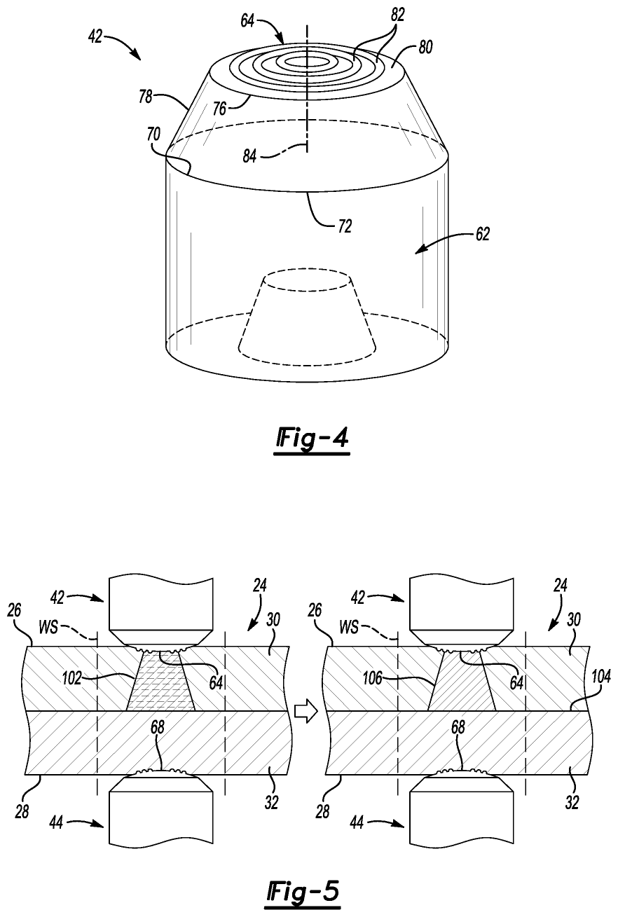

Referring now to FIG. 4, the first welding electrodes 42 is illustrated in more detail, and it should be understood that the welding electrode 44 may be identical to the welding electrode 42 or may be different from electrode 42. The electrode body 62 of the MRD welding electrode 42 is preferably cylindrical in shape and includes a front end 70 having a circumference 72. The weld face 64 is disposed on the front end 70 of the body 62 and has a circumference 76 that is coincident with the circumference 72 of the front end 70 of the body 62 (a “full face electrode”) or is upwardly displaced from the circumference 72 of the front end 70 by a transition nose 78 of frustoconical or truncated spherical shape. In terms of its shape, the weld face 64 includes a base weld face surface 80 that is convexly domed and a series of upstanding circular ridges 82 that project outwardly from the base weld face surface 80. Under the relatively high loads imposed on the welding electrode 42 during spot welding, these circular ridges 82 enable the MRD welding electrode 42 to establish good mechanical and electrical contact with an aluminum workpiece surface by stressing and fracturing the mechanically tough and electrically insulating refractory oxide layer that is typically present in an aluminum workpiece over the aluminum substrate, yet they do not materially interfere with current communication into and through a steel workpiece. The series of upstanding circular ridges 82 are preferably centered about and surround a central axis 84 of the weld face 64. The base weld face surface 80 from which the ridges 82 outwardly project may account for 50% or more, and preferably between 50% and 80%, of the total surface area of the weld face 64. The remaining surface area is attributed to the series of upstanding circular ridges 82, which preferably includes anywhere from two ridges to ten ridges, or more narrowly from three to five ridges.

As an alternative to the upstanding circular ridges 82, the oxide-disrupting structural features included on the weld face 64, 68 of either of the welding electrodes 42, 44 may include a series of recessed circular grooves or a microtexture that comprises random three-dimensional peaks-and-valleys. Likewise, other weld face 64, 68 configurations could be used. Some such variations are shown in U.S. Pat. App. Pub. No. 2017/0304928, which is hereby incorporated by reference in its entirety.

The series of upstanding circular ridges 82 or other surface features can stretch and fracture the mechanically tough and electrically insulating refractory oxide surface layer that often covers the surface of an aluminum workpiece 30, leading to the mechanical breakdown of the oxide layer, which helps establish good mechanical, electrical, and thermal contact between the weld face 64 and the aluminum workpiece 30. The ridges 82 (or other surface features) do not have any particular function when brought into contact with a steel workpiece 32 and, in fact, the ridges 82 are quickly plastically deformed and flattened, but not entirely eliminated, at the temperatures achieved in the steel workpiece 32 during welding. The domed shape of the weld face 68 is the feature that enables the welding electrode 44 to concentrate current and heat within the steel workpiece 32 as needed to form an aluminum-to-steel spot weld.

Referring back to FIG. 3, the weld gun 40 is operable to pass electrical current between the facially-aligned weld faces 64, 68 of the first and second welding electrodes 42, 44 and through the workpiece stack-up 24 at the weld site WS. The exchanged electrical current is preferably a DC (direct current) electrical current that is delivered by the power supply 46 which, as shown, electrically communicates with the first and second welding electrodes 42, 44. The power supply 46 is preferably a medium frequency direct current (MFDC) inverter power supply that includes a MFDC transformer. A MFDC transformer can be obtained commercially from a number of suppliers including Roman Manufacturing (Grand Rapids, Mich.), ARO Welding Technologies (Chesterfield Township, Mich.), and Bosch Rexroth (Charlotte, N.C.). The characteristics of the delivered electrical current are controlled by the weld controller 48. Specifically, the weld controller 48 allows a user to program a weld schedule that sets the waveform of the electrical current being exchanged between the welding electrodes 42, 44. The weld schedule allows for customized control of the current level at any given time and the duration of current flow at any given current level, among others, and further allows for such attributes of the electrical current to be responsive to changes in very small time increments down to fractions of a millisecond.

The weld gun 40 is used to form spot welds needed to structurally support the multi-component integrated body-in-white assembly 10. Referring now to FIG. 5, the workpiece stack-up 24 is spot welded to form an initial aluminum-steel spot weld 106. The formation of the initial aluminum-to-steel spot weld 106 begins by pressing the weld face 64 of the first welding electrode 42 and the weld face 68 of the second welding electrode 44 against the first side 26 and the second side 28, respectively, of the workpiece stack-up 24 at the weld site WS under an imposed clamping force in a first relative position between the set of electrodes 42, 44 and the workpieces 30, 32. The force applied by the welding electrodes 42, 44 ranges from 400 lb to 2000 lb and preferably from 600 lb to 1300 lb, by way of example.

Once the electrodes 42, 44 are pressed in place, the electrodes 42, 44 are initially energized to pass an electrical current between the facially-opposed weld faces 64, 68 and through the workpiece stack-up 24. The passing of electrical current generates heat and creates a molten aluminum weld pool 102 within the aluminum workpiece 30 that lies adjacent to and contacts the steel workpiece. The molten aluminum weld pool 102 wets the adjacent steel workpiece, which does not contribute molten material to the weld pool 102, and penetrates into aluminum workpiece, typically to a distance of 10% to 100% of its thickness and preferably 20% to 80%, from a faying interface 104 established between the aluminum and steel workpieces 30, 32. Upon ceasing passage of the electrical current, the molten aluminum weld pool 102 solidifies into an attempt at an initial weld joint 106 that is intended to weld bond or braze the aluminum and steel workpieces together. In some cases, the weld joint 106 is successful in bonding/attaching the workpieces 30, 32 together, while in other cases, the attempted weld joint 106 is discrepant and the attempted weld joint 106 does not bond the workpieces 30, 32 together or creates merely a weak bond between the workpieces 30, 32.

The structure of the aluminum weld joint 106 formed within the workpiece stack-up(s) 24 at each weld site WS is essentially the same at the faying interface 104 regardless of whether any additional metal workpieces are included in the stack-up 24b. If any additional faying interfaces—i.e., interfaces besides of the faying interface 104 established between the aluminum and steel workpieces—are established within the workpiece stack-up 24, such as between two aluminum workpieces and/or between two steel workpieces (such shown in FIGS. 2A-2B), then an additional weld nugget may or may not be formed as part of the aluminum-to-steel spot weld 106. Specifically, if one or more aluminum workpieces are included in the workpiece stack-up 24, the aluminum weld joint 106 simply extends through the additional overlapping aluminum workpieces. If, however, one or more steel workpieces are included in the workpiece stack-up 24, a separate steel weld nugget may form within the steel workpieces in addition to the aluminum weld joint 106.

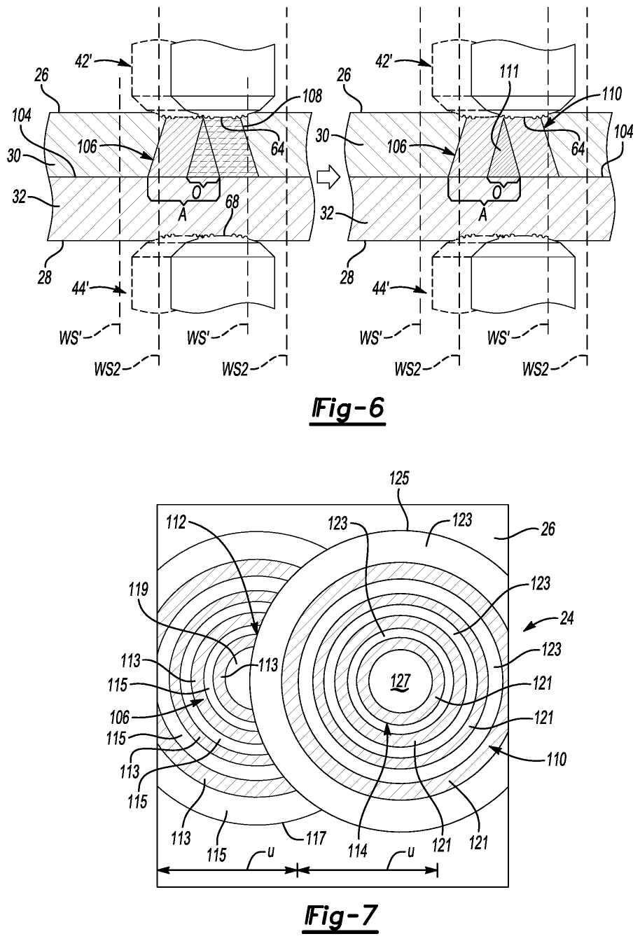

After applying the initial application of pressure to the workpieces 30, 32 and passing current through the workpieces 30, 32 via the first and second electrodes 42, 44 in the first relative position between the set of electrodes 42, 44 to form the initial spot weld joint attempt 106, as shown in FIG. 5, the first application of pressure is removed and the electrodes 40, 42 are moved away from contacting the workpieces 30, 32. Then, the first and second electrodes 42, 44 and/or the workpieces 30, 32 are moved so that the set of electrodes 42, 44 and the workpieces 30, 32 are in a second relative position with respect to each other. Similarly, as in the first relative position, in the second relative position, the first and second electrodes 42, 44 are pressed against the outer sides 26, 28 of the workpieces 30, 32 and used to apply pressure (a subsequent application of pressure) to the workpieces 30, 32 via the weld faces 64, 68 of the set of electrodes 42, 44 and current is passed through the workpieces in the second relative position. In FIG. 6, the previous weld site is shown as WS' and the previous position of the electrodes are illustrated in dotted line configuration and labeled as 42′, 44′. The new weld site is shown as WS2. In FIG. 6 the overlapping weld joint is characterized by overlapping weld nuggets 106 and 110, with an overlapping portion 111. In addition, the workpieces 30, 32 will have overlapping electrode imprints on the aluminum workpiece 30 (as shown best in FIG. 7), and overlapping electrode imprints on the steel workpiece 32 on the outer side 28, but not shown in the figures. In general, the defining feature of the overlapping weld is the overlap of the weld nuggets 106, 110 to create an enlarged nugget that is the sum of the weld nuggets 106, 110 and has an overlapping portion 111. The amount of overlap is determined by the area A at the faying interface 104 for nugget 106 and area O at the faying interface 104 of the intersection defined by 111, so that the overlap percentage is O divided by A.

Similarly as in the first relative position, in the second relative position between the electrodes 42, 44 and the workpieces 30, 32, at the second weld site WS2, the electrodes 42, 44 are pressed against the workpieces 30, 32 and pass an electrical current between the facially-opposed weld faces 64, 68 and through the workpiece stack-up 24. The passing of electrical current flow generates heat and creates a molten aluminum weld pool 108 within the aluminum workpiece 30 that lies adjacent to the steel workpiece. The molten aluminum weld pool 108 wets the adjacent steel workpiece 32, similarly to the weld pool 102, and the steel workpiece 32 penetrates into aluminum workpiece 30, typically to a distance of 10% to 100% or more preferably 20% to 80% of its thickness, from the faying interface 104 established between the aluminum and steel workpieces 30, 32. Upon ceasing passage of the electrical current, the molten aluminum weld pool 108 solidifies into an overlapping weld joint 110 that weld bonds or brazes the aluminum and steel workpieces 30, 32 together and strengthens the initial weld joint 106. In this example, the initial weld joint 106 is successful in bonding the workpieces 30, 32 together, but the additional overlapping weld joint 110 strengthens the overall bond between the workpieces 30, 32, which now includes a combined weld joint comprising the overlapping weld joints 106, 110 with an overlapping portion 111. Thus, the initial spot weld joint attempt results in an initial spot weld joint 106 that bonds the first workpiece 30 to the second workpiece 32, and the overlapping weld joint 110 further bonds the first workpiece 30 to the second workpiece 32.

The overlapping weld nuggets 106, 110 may overlap by any desired amount. In some examples, the initial weld nugget 106 and the subsequent weld nugget may overlap by 10-75%, or by 25-50%. The overlapping portion of the nuggets 106, 110 may be defined at the faying surface 104, such that the overlapping percentage is O divided by A, with reference to FIG. 6.

As explained above and shown in FIGS. 2A and 2B, a third workpiece 34, a fourth workpiece 36, or more additional workpieces may be disposed between the first and second workpieces 30, 32, and as such, the additional workpieces 34, 36 would be spot welded to the first and second workpieces 30, 32 by the initial spot weld joint 106 (when successful) and the overlapping spot weld joint 110.

Referring to FIG. 7, a plan view of an outer surface 26 of the stack-up 24 is shown. In addition, to the weld nuggets 106, 110 overlapping as shown in FIG. 6, weld impressions 112, 114 may overlap. More specifically, the electrode 42 (shown in FIGS. 4-6) has created welding imprints, indentations, or impressions 112, 114 (referred to hereinafter as impressions, for simplicity) in the outer surface 26 corresponding to the first and second relative positions between the workpieces 30, 32 and the electrodes 42, 44. The electrode 42 has created weld impressions 112 over the initial weld joint 106. The weld impressions 112 include imprinted rings 113 as well as surfaces 115 between each imprinted ring 113 and up to a marking 117 corresponding to the diameter 76 (see FIG. 4) of the electrode 42, as well as a center portion 119. Similarly, the electrode 42 has created weld impressions 114 over the subsequent overlapping weld joint 110, which include imprinted rings 121 as well as surfaces 123 between each of the imprinted rings and up to a marking 125 corresponding to the diameter 76 (see FIG. 4) of the electrode 42, as well as a center portion 127. As can be seen in FIG. 7, the first and second weld impressions 112, 114 overlap, similarly to the weld joints 106, 110 themselves. In one example, like the weld joints 106, 110, the weld impressions 112, 114 overlap by 10-100%, or by 25-50%, but typically, the weld impressions 112, 114 will overlap by a greater amount than the weld nugget joints 106, 110.

In one example, such as the example shown in FIG. 7, the weld impressions 112, 114 have an outer diameter in the range of 7-15 millimeters. For example, a scale is illustrated in FIG. 7 showing units u that are each equal to five millimeters. As such, it can be seen that the weld impressions 112, 114 form rings wherein the outermost ring would have a diameter that is equal to about two of the units u, or about 10 millimeters. However, it should be understood that the dimensions may vary and have other ranges, depending on the application.

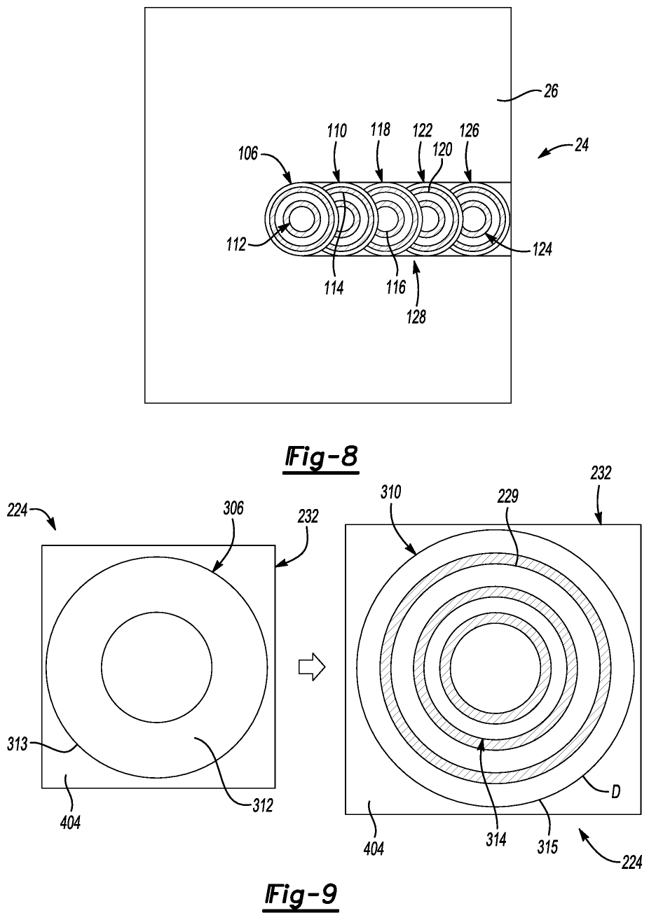

Referring now to FIG. 8, a plan view of the outer surface 26 of the stack-up 24 is shown after further overlapping weld joints are formed. In addition to the weld impressions 112, 114 forming weld joints 106, 110, the electrode 42 (shown in FIGS. 4-6) has created weld impressions 116, 120, 124 in the outer surface 26 corresponding to third, fourth, and fifth relative positions between the workpieces 30, 32 and the electrodes 42, 44. The electrode 42 has imprinted weld impressions 116 over a weld joint 118 that overlaps with the weld joint 110, weld impressions 120 over a weld joint 122 that overlaps with the weld joint 118, and weld impressions 124 over a weld joint 126 that overlaps with the weld joint 122. As can be seen in FIG. 8, the second and third weld impressions 114, 116 overlap, as do the weld joints 110, 118 themselves; the third and fourth weld impressions 116, 120 overlap, as do the weld joints 118, 122 themselves; and the fourth and fifth weld impressions 120, 124 overlap, as do the weld joints 122, 126 themselves. As explained above, like the overlapping adjacent weld joints 106, 110, 118, 122, 126, the adjacent weld impressions 112, 114, 116, 120, 122 may overlap by 10-100%, or by 25-50%, as desired. The initial spot weld joint 106, the second spot weld joint 110, the third spot weld joint 118, the fourth spot weld joint 122, and the fifth spot weld joint 126 form a continuous weld joint 128 between the first and second workpieces 30, 32. Any number of spot weld joints 106, 110, 118, 122, 126 may be formed in overlapping offset fashion to form a continuous weld joint 128, such as two, three, four, five, six, seven, to “N” number of overlapping spot weld joints. Thus, as shown in FIGS. 5-8, a spot-welded workpiece assembly is provided that includes first and second workpieces spot welded together by a plurality of overlapping spot weld joints 106, 110, 118, 122, 126.

In the example of FIG. 8, each weld joint 106, 110, 118, 122, 126 is illustrated having a smaller diameter than the version shown in FIG. 7. For example, each weld joint 106, 110, 118, 122, 126 has weld impressions 112, 114, 116, 120, 124 having outer diameters on the order of 4-7 millimeters, or about 5 millimeters.

Referring now to FIG. 9, a pulled-away plan view of another stack-up 224 is illustrated, and it should be understood that the stack-up may include any of the variations of workpieces described above. In one example, the stack-up originally included an aluminum or aluminum alloy workpiece that was spot welded, or attempted to be spot welded, to a steel workpiece 232 having a faying surface 404. An electrode (such as the electrode 42 shown in FIGS. 4-6) has created welding marks or a contact zone 312 that contains the weld nugget in the faying surface 404 when attempting to form an initial weld joint 306, but the weld joint 306 turned out cold and discrepant and did not form a good bond. Therefore, it was easy to pull the aluminum workpiece away from the steel workpiece 232 after the initial weld attempt, as shown on the left side in FIG. 9. The contact zone 312 shows no appreciable amount of aluminum stuck to the steel surface 404. Thus, no weld joint, or sufficient weld joint formed. The weld contact zone 312 has an overall boundary mark 313.

To perform the method of repairing a weld that is either known to be weak or is suspected of being weak, as disclosed herein, the workpieces are then realigned with the electrodes in the same or substantially same position as when forming the initial weld joint attempt 306. For example, the electrode 44 may be aligned with the weld contact zone 312 and contact zone boundary 313, as well as electrode impressions formed on an outer side of the workpiece 232, and the other electrode 42 may be aligned with weld impressions that were formed in the first workpiece (not shown) due to the first unsuccessful weld attempt. The pair of opposing electrodes then performs the spot welding operation again over the first attempted weld 306 to remelt the aluminum workpiece (not shown). For example, the electrodes are used to apply pressure to the workpieces via the weld faces of the set of electrodes at a contact point that overlaps with the initial weld markings 312, and an electrical current is passed through the electrodes, to form a repaired spot weld joint between the first and second workpieces.

Referring to the right side of FIG. 9, after performing the overlapping spot weld for the repaired weld joint, the aluminum was then ripped or pulled away to reveal a weld “button” 314 of aluminum bonded to the underlying steel workpiece 232, which includes several rings 229 from the aluminum formed on and attached to the steel faying surface 404. This indicates that a high quality repaired weld joint had been formed.

The repaired spot weld joint may be created any desired amount of time after the first weld attempt 306. For example, in some variations, one could wait a period of time, such as until after the workpieces have cooled down to room temperature after the first weld attempt 306 was formed, and then perform the overlapping weld joint by applying pressure to the workpieces in the same relative position between the set of electrodes and the workpieces that was used to form the initial spot weld joint attempt 306. In some variations, the time period between performing the initial weld attempt 306 and performing the overlapping weld is much shorter, such as only at least one second, two seconds, or a few seconds apart. In yet other variations, there is no minimum time period between performing the initial weld attempt 306 and the overlapping weld.

In the example of FIG. 9, the repaired weld joint 310 may have an outer diameter D in the range of about 7-15 mm, or about 10 mm, similar to the version shown in FIG. 7.

The repaired overlapping weld 310 may completely overlap or substantially overlap with the initial weld attempt 306. For example, weld nuggets formed by the overlapping welds may overlap by 95-100%. In some examples, a weld nugget formed in the initial weld attempt will be 100% consumed by a nugget formed by the second weld. Similarly, a repaired weld impression 314 formed when the weld is repaired has an overall contact zone boundary at the faying interface 315 formed by the overlapping weld joint. The contact zone boundary 315 of the repaired weld may overlap with the initial overall contact zone boundary 313 by 95-100%. In the illustrated example, the overlapping overall contact zone boundary 315 is larger than the initial overall contact zone boundary 313. Thus, the overlapping overall contact zone boundary 315 overlaps with 100% of the initial contact zone boundary 313.

In all examples, the weld gun 40 can be configured so that each spot weld joint or attempted weld joint 106, 110, 118, 122, 126, 306, 310 is formed according to its own unique weld schedule depending on the gauge, workpiece substrate composition, workpiece surface coating composition, stack-up thickness, etc. And while any suitable weld schedule may be employed to carry out formation of the aluminum-to-steel spot welds or attempted welds 106, 110, 118, 122, 126, 306, a particularly preferred weld schedule is disclosed in U.S. Pat. App. Pub. No. 2017/0106466, the entire contents of which are incorporated herein by reference.

The detailed description and the drawings or figures are supportive and descriptive of the many aspects of the present disclosure. The elements described herein may be combined or swapped between the various examples. For example, except where described as being different, the details described with respect to FIGS. 1-8 may be applied to the example shown in FIG. 9. While certain aspects have been described in detail, various alternative aspects exist for practicing the invention as defined in the appended claims. The present disclosure is exemplary only, and the invention is defined solely by the appended claims.

What is claimed is:

1. A method of resistance spot welding workpiece stack-ups, the method comprising:
providing a first workpiece stack-up including at least a metallic first workpiece and a metallic second workpiece, the first workpiece being formed of one of aluminum and an aluminum alloy;
providing a set of opposed welding electrodes including a first electrode and a second electrode, the first electrode having a first weld face and the second electrode having a second weld face, the first electrode being first disposed on a side of the first workpiece in a first relative position between the set of electrodes and the workpieces, and the second electrode being first disposed on a side of the second workpiece in the first relative position between the set of electrodes and the workpieces;
initially applying an initial application of pressure to the workpieces via the weld faces of the set of electrodes in the first relative position between the set of electrodes and the workpieces and heating the workpieces via the electrodes to form an initial spot weld joint attempt between the first and second workpieces;
after initially applying the initial application of pressure to the workpieces via the weld, removing the initial application of pressure; and
after removing the initial application of pressure, subsequently applying a subsequent application of pressure to the workpieces via the weld faces of the set of electrodes and heating the workpieces via the electrodes to form an overlapping spot weld joint between the first and second workpieces, the overlapping spot weld joint overlapping with the initial spot weld joint attempt.

2. The method of claim 1, wherein the second workpiece is formed of a steel alloy and the first workpiece is formed of one of aluminum and an aluminum alloy.

3. The method of claim 2, further comprising:
contacting the first workpiece with the first weld face during the initial application of pressure;
removing contact between the first weld face and the first workpiece during the step of removing the initial application of pressure; and
contacting the first workpiece with the first weld face during the subsequent application of pressure,
wherein the steps of heating the workpieces are accomplished by passing electrical current between the workpieces via the electrodes.

4. The method of claim 1, wherein the overlapping spot weld joint overlaps with the initial spot weld joint attempt by 95-100%.

5. The method of claim 4, the step of subsequently applying the subsequent application pressure to the workpieces being performed in the first relative position between the set of electrodes and the workpieces.

6. The method of claim 5, wherein the initial spot weld joint attempt results in a discrepant weld, the method further comprising waiting a predetermined period of time after the step of applying the initial application of pressure to the workpieces and prior to performing the step of applying the subsequent application of pressure to the workpieces, the predetermined period of time being at least one second.

7. The method of claim 1, the step of subsequently applying the subsequent application pressure to the workpieces being performed in a second relative position between the set of electrodes and the workpieces, the second relative position being different than the first relative position, wherein the overlapping spot weld joint forms an overlapping nugget that overlaps with an initial nugget formed by the initial spot weld joint attempt, the overlapping nugget overlapping with the initial nugget by 10-75% at a faying interface.

8. The method of claim 7, wherein the overlapping nugget overlaps with the initial nugget by 25-50% at the faying interface.

9. The method of claim 7, wherein the initial spot weld joint attempt results in an initial spot weld joint that bonds the first workpiece to the second workpiece, the overlapping weld joint further bonding the first workpiece to the second workpiece.

10. The method of claim 9, the overlapping spot weld joint being a second spot weld joint, the method further comprising:
after subsequently applying the subsequent application of pressure, removing the subsequent application of pressure; and
applying a third application of pressure to the workpieces via the weld faces and heating the workpieces in a third relative position between the set of electrodes and the workpieces to form a third spot weld joint between the first and second workpieces, the third relative position between the set of electrodes and the workpieces being different than each of the first and second relative positions between the set of electrodes and the workpieces, the third overlapping spot weld joint overlapping with the second spot weld joint so that the initial spot weld joint, the second spot weld joint, and the third spot weld joint form a continuous weld joint between the first and second workpieces.

11. The method of claim 2, further comprising disposing a metallic third workpiece between the first and second workpieces, the third workpiece being spot welded to the first and second workpieces by the overlapping spot weld joint, the third workpiece between formed of one of the following: a steel alloy, aluminum, and an aluminum alloy.

12. A spot-welded workpiece assembly comprising:
a metallic first workpiece; and
a metallic second workpiece spot welded to the first workpiece by a plurality of overlapping spot weld joints, each overlapping spot weld joint overlapping with another overlapping spot weld joint of the plurality of overlapping spot weld joints by 10-100%.

13. The spot-welded workpiece assembly of claim 12, the second workpiece being formed of a steel alloy and the first workpiece being formed of one of aluminum and an aluminum alloy.

14. The spot-welded workpiece assembly of claim 13, wherein each overlapping spot weld joint overlaps with another overlapping spot weld joint of the plurality of overlapping spot weld joints by 95-100%.

15. The spot-welded workpiece assembly of claim 13, wherein each overlapping spot weld joint overlaps forms a weld nugget that overlaps with a weld nugget of another overlapping spot weld joint of the plurality of overlapping spot weld joints by 10-75% at a faying interface between the first and second workpieces.

16. The spot-welded workpiece assembly of claim 14, wherein the plurality of overlapping spot weld joints comprise at least three overlapping spot weld joints that form a continuous weld joint between the first and second workpieces.

17. A method of repairing a discrepant weld joint, the method comprising:
providing a metallic first workpiece;
providing a metallic second workpiece adjacent to the first workpiece, wherein each of the first and second workpieces have an initial weld impression formed therein from a previous spot weld attempt between the first and second workpieces;
providing a first electrode adjacent to the initial weld impression formed in the first workpiece, and providing a second electrode adjacent to the initial weld impression formed in the second workpiece, each of the first and second electrodes having a weld face; and
applying pressure to the workpieces via the weld faces of the set of electrodes at contact points that overlap with the initial weld impressions and passing current through the workpieces via the electrodes to form a repaired spot weld joint between the first and second workpieces.

18. The method of claim 17, wherein the initial weld impressions are overall weld impressions, the method further comprising forming a repaired overall weld impression on each of the first and second workpieces, wherein each repaired overall weld impression overlaps with an initial overall weld impression by 95-100%.

19. The method of claim 18, wherein the second workpiece is formed of a steel alloy and the first workpiece is formed of one of aluminum and an aluminum alloy.

20. The method of claim 19, further comprising disposing a metallic third workpiece between the first and second workpieces, the third workpiece being spot welded to the first and second workpieces by the repaired spot weld joint, the third workpiece being formed of one of the following: a steel alloy, aluminum, and an aluminum alloy.
